(19) United States
(12) Patent Application Publication
(10) Pub. No.: US 2006/0153128 A1
(43) Pub. Date: Jul. 13, 2006

(54) Transmitting information using multiple carriers

(76) Inventors: Frank Frederiksen, Klarup (DK); Klaus Ingemann Pedersen, Aalborg (DK); Preben Mogensen, Gistrup (DK)

Correspondence Address: ROBERT M BAUER, ESQ.;LACKENBACH SIEGEL, LLP, 1 CHASE ROAD, SCARSDALE, NY, 10583, US

(21) Appl. No.: 11/263,708

(22) Filed: Nov. 1, 2005

(30) Foreign Application Priority Data
Jan. 10, 2005 (GB) 0500416.3

(51) Int. Cl. H04Q 7/00

(52) U.S. Cl. 370/329

(57) ABSTRACT

A communication network has a network element adapted to transmit data to a mobile station using at least two carriers. The network element transmits a first set of channels on a first main carrier, and a second set of channels on a second dependent carrier. The first and second set of channels may include a shared downlink channel, but are otherwise different each other.

### RELATED APPLICATION

This application claims priority under 35 USC §119 to Great Britain Application No. GB 0500416.3, filed Jan. 10, 2005, which is incorporated herein by reference in its entirety.

### FIELD OF THE INVENTION

This invention relates to telecommunications. In particular, the invention relates to the wireless transmission of information using more than one carrier.

### BACKGROUND OF THE RELATED ART

At least the following acronyms are used in this specification:
3GPP Third Generation Partnership Project
CPICH common pilot channel
CQI channel quality indicator
DCH dedicated channel
DPCH dedicated physical channel
HSDPA high speed packet data access
HS-DSCH high speed downlink shared channel
HS-SCCH shared control channel for HS-DSCH
MC-HSDPA multi carrier high speed packet data access
P-CPICH primary common pilot channel
TTI transmission time interval
UMTS Universal Mobile Telecommunications System
WCDMA Wideband Code Division Multiple Access

Several third generation (3G) cellular communications systems have been developed and standardized. For example, the Third Generation Partnership Project (3GPP) developed and released several specifications for an improved WCDMA/UMTS wireless communication system designed to deliver high speed data communications as well as voice communications. Release 5 of the 3GPP specifications described a high speed downlink packet access (HSDPA) providing the potential for high peak data rates as well as the possibility for having a high spectral efficiency. See, for example, 3GPP TS 25.308 v 5.2.0 (2002-03) for an overall description and details.

HSDPA carriers carry a common pilot channel (CPICH), which is a downlink physical channel that carries a pre-defined bit/symbol sequence, and a high speed downlink shared channel (HS-DSCH), which is a time multiplexed downlink data channel shared by several mobile stations. Common pilot channels are used to provide a phase reference to other channels. There may be both a primary common pilot channel and a secondary common pilot channel, which differ in their use and the limitations placed on their physical features. For example, see 3GPP TS 25.211 v 5.0.0 (2002-03). The HS-DSCH may be associated with one downlink dedicated physical channel (DPCH), and one or more downlink high speed shared control channels (HS-SCCH). The HS-DSCH channel can be transmitted over an entire cell or over only part of the cell using, for example, beam-forming antennas. See, for example, 3GPP TR 25.858 v 5.0.0 (2002-03).

### BRIEF SUMMARY

The preferred embodiments of the present invention seek to provide wireless communications with improved peak data rates, throughput, and spectral efficiency. The embodiments may, but need not be, implemented as a multiple carrier HSDPA configuration (MC-HSDPA) by way of an improvement to HSDPA as described in Release 5 of the 3GPP specifications.

In one aspect of these embodiments, a communication network has a network element adapted to transmit data to a mobile station using at least two carriers. The network element transmits a first set of channels on a first main carrier, and a second set of channels on a second dependent carrier. The first and second set of channels may include a shared downlink channel, but are otherwise different each other.

### BRIEF DESCRIPTION OF THE DRAWINGS

Preferred embodiments of the present invention will now be described by way of example with reference to the accompanying drawings, in which:

FIG. 1 illustrates the channel structure of a preferred embodiment with two carriers;

FIG. 2 illustrates an exemplary scheduling of transmissions from a base station to mobile stations in the preferred embodiment of FIG. 1, and

FIG. 3 shows examples of a base station and a mobile station in the preferred embodiment of FIG. 1.

### DETAILED DESCRIPTION OF THE PREFERRED EMBODIMENTS

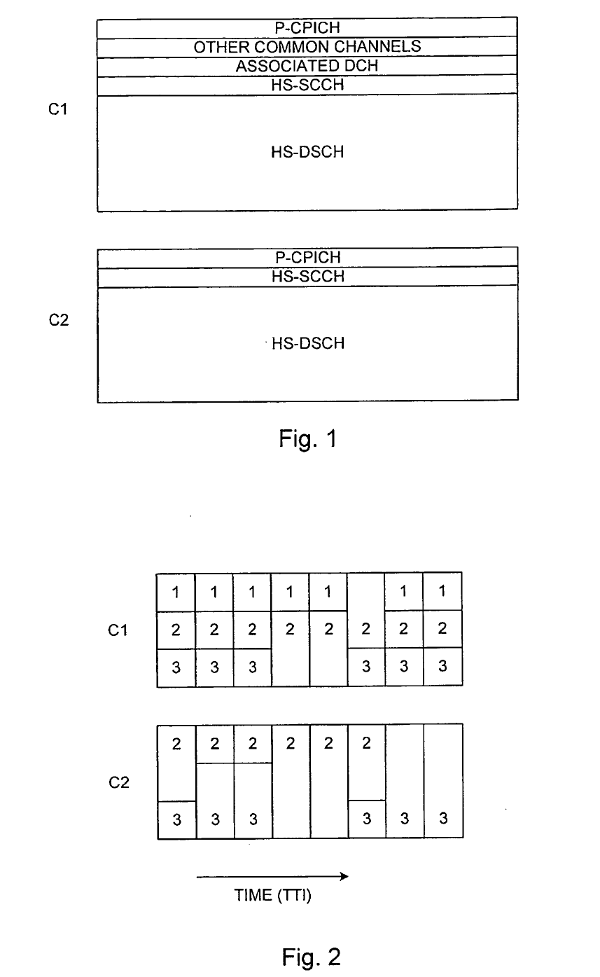

According to the preferred embodiments illustrated in FIG. 1-3 and described below, two HSDPA carriers are used for multi-carrier downlink transmissions in a 3G cellular network. However, these preferred embodiments are exemplary and non-limiting, and the invention also includes other embodiments which may differ from these preferred embodiments insofar as they have more than two carriers, do not use HSDPA carriers, are not in a 3G cellular network or in some other respect.

According to a further embodiment, the network does not communicate information about transmissions on the dependent carriers on the main carrier. Mobile stations able to utilize the multi carrier transmissions need to receive and decode these dependent carrier(s) to find out if data is transmitted on these. Using this solution, a high level of backwards compatibility is maintained, since mobile stations which are only capable of receiving one downlink carrier do not need to know about the dependent carriers, and do not need to handle any messaging related to the dependent carriers. Therefore, even mobile stations which are not equipped to work with the inventive multi carrier transmission method can continue to work with a base station using prior art single carrier methods, even if the same base station would transmit multi carrier transmissions to other mobile stations.

FIG. 1 illustrates the channel structure of a preferred embodiment with two downlink carriers C1 and C2. The two carriers are associated with each other in the sense that the first carrier C1 is a main carrier, and the second carrier C2 is a dependent carrier which does not carry all the same channels as the main carrier. The dependent carrier C2 is not operated as an identical, redundant, independent carrier, but instead as a further transmission resource for downlink transmissions.

The exemplary, non-limiting, channel structure of FIG. 1 represents an implementation within a third generation network, the channel naming being consistent with 3GPP standards. In this channel structure, the two carriers are not identical and differ as shown. Both the main HSPDA carrier C1 and the dependent HSPDA carrier C2 utilize the pilot channel (P-CPICH) and include the HSDPA related channels, that is, HS-DSCH and HS-SCCH. However, only the main carrier C1 includes certain other common channels, as well as the associated DCH channel. The dependent carrier C2 (and any further carriers in other embodiments) only carries channels related to keeping the HSDPA functioning (i.e., the common pilot channel, the HS-DSCH channel, and the HS-SCCH channel needed for signalling related to the HS-DSCH channel).

Optionally, the differences between main carrier C1 and dependent carrier C2 may be greater. For example, main carrier C1 may carry all signalling related to the transmissions on the downlink shared channel in the dependent carrier C2. This signalling can, for example, be carried in the same signalling channel of main carrier C1 that carries signalling information for the downlink shared channel of the main carrier C1 or it may be carried in a separate signalling channel in main carrier C1. In such an optional embodiment, the dependent carrier C2 does not need to carry signalling channels related to the downlink shared channels in dependent carrier C2, which saves transmission capacity on dependent carrier C2.

FIG. 2 illustrates an example of the scheduling of transmissions to three mobile stations on the downlink shared channels in carriers C1 and C2. FIG. 2 illustrates a situation in which a base station transmits data on two carriers to three mobile stations, where a first one of the mobile stations, mobile station 1, is only capable of receiving one of the carriers. In the example of FIG. 2, main carrier C1 carries data for all three mobile stations, while the dependent carrier C2 carries data only for mobile stations 2 and 3. The data for a mobile station that is transmitted to the mobile station over multiple carriers can be transmitted either in independent data blocks for each carrier, or the data can be transmitted using coding across the carriers.

A scheduler in the network is adapted to be capable of exploiting the potential frequency diversity between the carriers as well as to perform fast load balancing between carriers. In particular, the scheduler may be able to provide roughly the same transmission power for the carriers. For the case where simultaneous scheduling on two carriers is used, the peak data rate may be doubled compared to the single carrier HSDPA scheme specified by 3GPP Release 5. In a 3GPP standards cellular system, the scheduler can be the MAC-hs (medium access control—high speed) packet scheduler in the Node B or it may be in another network element.

Mobile stations able to receive multi carrier transmissions may be required to listen and decode all carriers that the network and the mobile station have negotiated to use, so that the network may schedule transmissions to the mobile station on none, one, or both of the carriers in every transmission time interval (TTI). This embodiment provides scheduling flexibility, as the scheduler can schedule transmission in the time domain, frequency domain, and between different users.

The mobile stations may also be adapted to report channel quality measurement results for a channel in each of the carriers, and the network may be arranged to receive the results. This allows the network to adjust transmission parameters and schedule packets while taking into account any possible differences in the conditions on the radio path for different carriers. In a 3GPP standards cellular system, the channel quality measurement results can be CQI (channel quality indicator) values.

It is also possible for a mobile station to report a single channel quality measurement result for all the carriers negotiated for use between the mobile station and the network. In such a case, the channel quality measurement result is advantageously an average of the measurement results for all of the carriers.

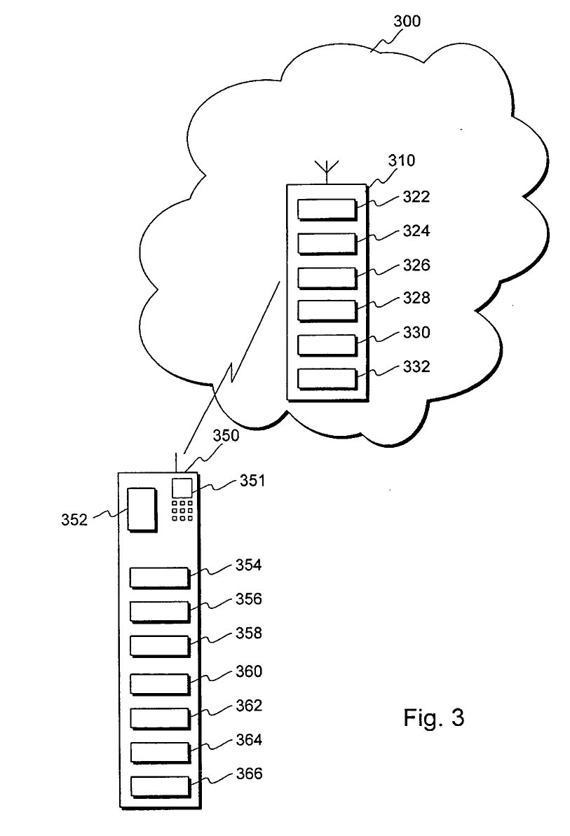

FIG. 3 illustrates an exemplary network element 310 and an exemplary mobile station 350 of a communication system 300. The network element 310, which can be for example a Node B network element or a base station, comprises a system including a function 322 of transmitting data to mobile station 350 on main carrier C1 and dependent carrier C2, a function 324 of transmitting a first set of channels on main carrier C1, and a function 326 of transmitting a second set of channels on dependent carrier C2. The network element 310 also comprises a function 328 of transmitting data to a plurality of mobile stations on each of the shared downlink channels of carriers C1 and C2, a transmission scheduler function 330 arranged to schedule transmissions to a mobile station in the time domain and over the shared downlink channels of carriers C1 and C2, and a function 332 of receiving channel quality measurement results for more than one carrier from a mobile station.

The transmission scheduler function 330 can be arranged to schedule transmissions to a plurality of mobile stations on a shared downlink channel on each of a plurality of carriers, and can be arranged to schedule transmissions within the time domain, among a plurality of receiving mobile stations, and over a plurality of carriers. In a 3GPP standards system, the transmission scheduler function 330 can be carried out by a MAC-hs scheduler. It may be arranged to schedule transmissions to a mobile station on a shared downlink channel on a previously negotiated number of carriers. In such a case, the communication network and a mobile station may negotiate the use of a plurality of carriers before commencing communication over the plurality of carriers. The negotiation process itself and the detailed signalling mechanisms are preferably dependent on the specifics of any particular network implementation as known to those of ordinary skill in the art.

Although shown as separate blocks in FIG. 3 for the ease of illustration, the functions need not be implemented by separate parts of network element 310 and may be implemented by the same part or through software which, when executed on a processor, cause network element 310 to perform the stated functions. The software can be provided as one or more distinct software program products or in other different forms, such as a software code library. The software code may have different parts that correspond respectively to preparing data to be transmitted on at least two carriers to a mobile station, transmitting a first set of channels on the first main carrier C1, and transmitting a second set of channels on the second dependent carrier C2, wherein the first and second set of channels comprise a shared downlink channel. The software can be stored and provided via any one of a number of different types of recording medium, such as a magnetic storage disk, an optical storage disk, or read-only memory. The software can also be provided via data transmission over a data network to memory such as random access memory of network element 310.

In a further embodiment, the first set of channels comprises a signalling channel related to the shared downlink channel on the first set of channels and at least one further channel, and the second set of channels comprises a signalling channel related to the shared downlink channel on the second set of channels. In a still further embodiment, the first set of channels comprises a signalling channel related to the shared downlink channels on the first and the second set of channels.

FIG. 3 also illustrates an exemplary mobile station 350. The mobile station comprises a user interface 351, a processor 352, and other conventional components of a mobile station which are, for purposes of clarity, not shown in FIG. 3. In terms of functionality, the mobile station comprises the function 354 of receiving transmissions simultaneously on at least two carriers, a function 356 of receiving a shared downlink channel on each of the at least two carriers, a function 358 of decoding transmissions received on the plurality of carriers, and a function 360 of determining from the decoded transmissions which transmissions received on the plurality of carriers are intended for reception by the mobile station.

The exemplary mobile station of FIG. 3 also comprises a function 362 of measuring channel quality on at least one channel on each of the at least two carriers, and a function 364 of reporting measured channel quality values. The mobile station further comprises a function 366 of negotiating, with the communications network, the number of carriers on which to receive transmissions on shared downlink channels.

Although shown as separate blocks in FIG. 3 for the ease of illustration, the functions need not be implemented by an equal number of parts of mobile station 350 and may be implemented by the same part or a smaller number of parts, or through software which, when executed on a processor, cause mobile station 350 to perform the stated functions. The software can be provided as one or more distinct software program products or in other different forms, such as a software code library. The software can be stored and provided via any one of a number of different types of recording medium, such as a magnetic storage disk, an optical storage disk, or read-only memory. The software can also be provided via data transmission over a data network to memory such as random access memory of mobile station 350.

The preferred embodiments of the present invention are thus believed to provide wireless communications with improved peak data rates and spectral efficiency relative to HSDPA as described in Release 5 of the 3GPP specifications by using a multiple carrier HSPDA configuration (MC-HSDPA). This configuration may be backwards compatible to 3GPP Release 5 and Release 6 single carrier HSDPA configurations, while allowing new multi carrier HSDPA mobile stations to achieve the potential for high peak data rates and throughput. The flexible scheduling over multiple carriers further increases the system throughput as compared to separate scheduling on separate carriers.

It is again noted that while the preceding preferred embodiments are implemented within a 3GPP cellular telecommunications system, and has several other characteristics, the invention is not limited to such a 3GPP cellular system and to such characteristics, but can be implemented in different types of cellular telecommunication systems and with other characteristics as well. It is also noted particularly that while the above describes exemplifying preferred embodiments of the invention, there are several variations and modifications which may be made to the preferred embodiments without departing from the scope of the present invention as defined in the appended claims.

The invention is not limited to the above preferred embodiments utilizing only two carriers and other embodiments can use more than two carriers. For example, in an embodiment in which a base station of the network transmits data to a mobile station on a group of HSDPA carriers (the group having a main carrier and one or more dependent carriers) and one or more additional independent HSDPA carriers, the scheduling of transmissions can be performed over all downlink shared channels of all of the carriers. A base station can transmit more than one independent HSDPA carrier for example to serve mobile stations conforming to 3GPP Release 5 specifications, and on one or more groups of dependent carriers to serve mobile stations capable of multi carrier operation.

The embodiments of the invention are not limited to any particular choices on the allocation of transmission power for high speed downlink transmissions, and do not limit any transmission parameters such as channelization codes on the plurality of carriers. Hence, the carriers may have roughly the same or different transmission resources for high speed downlink packet transmissions.

We claim:

1. A communications system comprising
a network element adapted to transmit data on at least two carriers; and
at least one mobile station adapted to receive data transmitted from said network element on said at least two carriers,
wherein said network element is adapted to transmit a first set of channels on a first carrier of said at least two carriers and a second set of channels, different than the first set of channels, on a second carrier of said at least two carriers, the first set of channels and the second set of channels each comprising a shared downlink channel.

2. A communications system according to claim 1, wherein the first set of channels comprises a signalling channel related to the shared downlink channel in the first set of channels, and the second set of channels comprises a signalling channel related to the shared downlink channel in the second set of channels.

3. A communications system according to claim 1, wherein the first set of channels comprises a signalling channel related to the shared downlink channels in the first set of channels and the second set of channels.

4. A communications system according to claim 1, wherein said network element is adapted to transmit data to a plurality of mobile stations on each of the shared downlink channels of said at least two carriers.

5. A communications system according to claim 1, further comprising a transmission scheduler adapted to schedule transmissions to a mobile station in the time domain and over the shared downlink channels of said at least two carriers.

6. A communications system according to claim 5, wherein the transmission scheduler is a MAC-hs scheduler.

7. A network element for use in a communication system, said network element being adapted to:
transmit data on at least two carriers to a mobile station,
transmit a first set of channels on a first carrier of said at least two carriers, and
transmit a second set of channels, said second set of channels being different than said first set of channels, on a second carrier of said at least two carriers,
wherein the first set of channels and the second set of channels each comprise a shared downlink channel.

8. A network element according to claim 7, wherein the first set of channels comprises a signalling channel related to the shared downlink channel in the first set of channels and at least one further channel, and the second set of channels comprises a signalling channel related to the shared downlink channel in the second set of channels.

9. A network element according to claim 7, wherein the first set of channels comprises a signalling channel related to the shared downlink channels in the first set of channels and the second set of channels.

10. A network element according to claim 7, further adapted to transmit data to a plurality of mobile stations on each of the shared downlink channels of said at least two carriers.

11. A network element according to claim 7, further comprising a transmission scheduler adapted to schedule transmissions to a mobile station in the time domain and over the shared downlink channels of said at least two carriers.

12. A network element according to claim 11, wherein the transmission scheduler is a MAC-hs scheduler.

13. A network element according to claim 7, wherein the network element is a base station.

14. A mobile station for use in a communications network, said mobile station being adapted to:
receive transmissions simultaneously on at least two carriers,
receive a shared downlink channel on each of said at least two carriers,
decode transmissions received on said at least two carriers, and
determine from the decoded transmissions which of the transmissions received on said at least two carriers are intended for reception by the mobile station.

15. A mobile station according to claim 14, further adapted to:
measure channel quality of at least one channel in each of said at least two carriers, and
report the measured channel quality values.

16. A mobile station according to claim 14, further adapted to negotiate with the communications network the number of carriers on which it will receive transmissions on shared downlink channels.

17. A software program stored on a tangible medium which, when executed by a network element of a communication system, causes the network element to:
prepare data to be transmitted on at least two carriers to a mobile station;
transmit a first set of channels on a first carrier of said at least two carriers; and
transmit a second set of channels, different than said first set of channels, on a second carrier of said at least two carriers,
the first set of channels and the second set of channels each comprising a shared downlink channel.

18. A software program according to claim 17, wherein the first set of channels comprises a signalling channel related to the shared downlink channel in the first set of channels and at least one further channel, and the second set of channels comprises a signalling channel related to the shared downlink channel in the second set of channels.

19. A software program according to claim 17, wherein the first set of channels comprises a signalling channel related to the shared downlink channels in the first set of channels and the second set of channels.
